(19) United States
(12) Patent Application Publication
(10) Pub. No.: US 2015/0112721 A1
(43) Pub. Date: Apr. 23, 2015

(54) Medical Transitional Care Patient Management System and Associated Business Method

(71) Applicant: Jphn Ogden Bloodsworth, JR., Sacramento, CA (US)

(72) Inventor: Jphn Ogden Bloodsworth, JR., Sacramento, CA (US)

(21) Appl. No.: 14/518,130

(22) Filed: Oct. 20, 2014

Related U.S. Application Data
(60) Provisional application No. 61/893,197, filed on Oct. 19, 2013.

(51) Int. Cl. G06F 19/00; G06Q 50/26

(52) U.S. Cl. CPC G06F 19/3418; G06Q 50/26; G06F 19/3487
USPC 705/3; 705/2

(57) ABSTRACT

The present invention pertains to novel medical post-discharge patient management system and associated business method that provides a means to track patients health after post-discharge using a program that employees a plurality of mathematical algorithms and software instructions for analyzing data that results in developing customized individual care plans that incorporate all of the unique co-morbidities of each patient. The system and software components includes an individual care plan (“ICP”) engine which receives data regarding the patient, their contact information and co-morbidities and uses the data to construct custom individualized care plans for each patient, based on their unique case mix of morbidities. The system software also includes IVR engine the works in conjunction with the ICP engine to contact patients using outbound interactive voice response, email and text messaging to ask the questions in the patients' CallPaths.

### RELATED APPLICATIONS

The present application is a non-provisional application of provisional application No. 61/893,197 filed on Oct. 19, 2013 entitled “Medical Post-Discharge Patient Management System and. Associated Business Method”. This Provisional applications is incorporated herein by this reference.

### FIELD OF THE INVENTION

The present disclosure relates to a system and business method that monitors patients before, during, and after a care transition related to a medical event. More specifically, the present invention is novel medical system and business method that provides a means to monitor, track and report patient health status, compliance with care instructions, and adverse health indicators before a care transition to or from a health care facility or health care provider, upon transition from a health care facility or health care provider, and through the recovery period, usually in the patient's home.

### BACKGROUND OF THE INVENTION

Millions of Americans experience a medical event and numerous care transitions related to those events. Assuring adequate continuity and coordination of care before, during, and after a care transition is known as “transitional care”, and is especially challenging because patients are not located with a care provider, but elsewhere, usually at home. Millions of Americans are hospitalized each year for a variety of ailments including chronic diseases. Patients are no longer admitted to a hospital to prepare for their medical treatment, receive their treatment, then recover in the hospital before they are, discharged to their homes. Today, patients are responsible for preparing for treatment at home, and after receiving their care, they no longer stay in the hospital but are discharged soon after and expected to manage their recovery at home. This is what is called a “routine discharger”. Lacking professional oversight in their preparation, complicated care instructions at discharge, and little or no monitoring once they arrive home, patients often develop complications that necessitate a visit to the emergency room, or readmission.

Compounding the transitional care challenge is the vast shift of medical and surgical procedures to outpatient care settings. Consequently, outpatient care centers are seeing more complicated patients that would have been treated in a hospital in the past, and the remaining hospital patients are also more complicated, with more co-morbidities, thus more intensive medical needs in the hospital, as well as while preparing to be admitted, at discharge, and during their subsequent recovery.

Many patients suffer from more than one disease state or morbidity. These patients are classified as ‘co-morbid’. The combination of their primary disease, co-morbidities, medical and/or surgical procedure, and risk factors is called their “case mix”. More complex case mixes in the outpatient and inpatient settings combined with the shift to home based medical event preparation and recovery, compounded by often rushed staff providing complicated discharge instructions as patients are discharged is evidenced by the significant number of complications resulting in emergency department visits and readmissions.

The health care costs associated with more complex case mixes is substantial. According to The Centers for Medicare and Medicaid Services (CMS), in 2010 Medicare Prospective Payment System (PPS) beneficiaries with four or more co-morbid chronic conditions made up 37% of the beneficiaries, but accounted for 74% of total Medicare PPS spending. Those with 6 or more chronic diseases, 14% of beneficiaries, accounted for 46% of the spending. Much of the cost is due to readmissions and emergency room visits. Improved transitional care and patient monitoring is required to help patients prepare for a medical event, ensure they understand their care instructions, and monitor their recovery at home.

Under the current Government and Commercial provider payment systems providers are financially incentivized to minimize the time spent in facilities. Medicare's prospective payment system pays a predetermined fixed fee based on the patient's ‘diagnosis related group’ (MG) to hospitals for a patient's care, regardless of the time spent in the facility. This incentivizes the hospital to “turn over” patient beds as quickly as possible.

Accordingly, patients are being admitted the day of a procedure, discharged sooner and are expected to recover at home. These patients are also often discharged with complex and confusing instructions that include changes to their medication regimes, what symptoms to monitor and who to call there is a problem, physician ordered durable medical equipment such as oxygen and walkers, and scheduling and attending multiple follow up appointments.

As a result of all of these factors, The Centers for Medicare and Medicaid Services (CMS) estimates that nearly 20% of discharged Medicare patients are readmitted to the hospital for issues related to their original condition, within the first 30 days following a hospital discharge. The most seriously patients are more likely to require readmission and CMS estimates that the 5 percent highest acuity patients can account for about 30 percent of all readmission costs. It is this group on which discharge efforts are mostly focused.

CMS data and industry studies show that readmissions can be reduced through post-discharge transitional care programs, yet efforts to date have yielded lackluster results. Many US hospitals have implemented post-discharge or “transitional” patient care programs and there are government and commercial payer initiatives and incentives for improving patient outcomes and reducing readmission. However, these programs are very labor intensive, and costly. They require significant investments in personnel, operations and training, information systems, and management to establish and operate the programs.

With limited resources and costly programs transitional care is generally limited to the hospital discharge care transition and to those discharged patients determined to be of “highest risk” for a readmission or emergent care visit. However, with the advent of new programs for managing the health of populations, and financial incentives for reducing the cost of care to Medicare and commercial health plans, some care systems are trying an alternative to targeting the high risk patients, they are attempting to reach out to all their patients post-discharge with programs designed to ensure proper understanding of the discharge instructions, and sometimes incorporate follow-up calls or visits to patients at home. Regardless of which model a care system chooses for post-discharge patient management, limited resources guarantees that the greater the number and depth of transitional care they provide, the fewer the number of their patients to whom they will be able to provide those programs.

With respect to this reality hospitals and care systems standardize their post-discharge care based on a patient's primary diagnosis. For example a patient diagnosed with congestive health failure (CHF) would be placed into a CHF post-discharge program. This would work fine for patients with just CHF, except today's more complex patients typically suffer from more than one disease state at the same time.

An example of this as a patient suffering from 1) congestive heart failure (CHF), 2) chronic obstructive pulmonary disease (COPD), 3) diabetes, 4) hypertension, and who was being hospitalized for 5) a total hip replacement (THA) Under the current model of care, this patient would likely be placed at discharge into a CHF program, as this is considered to be the most potentially deadly of the five conditions. This patient's other four disease states (COPD, diabetes, hypertension and the hip wound) would merely be considered as increased risk factors for a readmission under CHF.

When a patient is classified by their primary condition, procedure, or discharge diagnosis it labels the patient by one primary condition, and accompanying co-morbidities treated as risk factors. Patients are then managed based on programmatic protocols, often ignoring many of their co-morbidities and other factors. This method of classifying patients by their single primary disease state is known as the ‘silo’ method because patients are put into a single treatment ‘silo’ regardless of co-morbidities and/or other factors.

The current post-discharge system poses five major problems:

1) Selecting, or stratifying the “high risk” patients for transitional care programs and disease management ignores the vast majority of patients. Focusing programs on the top 5% of conditions accounting for 30% of readmission costs, ignores the other 95% of patients generating 70& of the readmission costs.

2) Stratifying patients using the silo method does not adequately account for all of the patients' co-morbidities, thus patients' co-morbid diseases are not adequately addressed by health care facilities, and health care providers during post-discharge transitional care.

3) Standardized programmatic practices and protocols based on primary diagnosis are used because there are not sufficient resources to build individual post-discharge transitional care plans for every patient that would take into account each patient's specific, unique case mix.

4) Placing patients in multiple disease management programs to manage transitional care would be cost prohibitive due to the significant cost of program coordination, and redundant investments in personnel, training, information systems.

5) It would be nearly impossible to get a patient to properly comply with multiple disease management programs, and there is a significant potential of conflicting protocols and contraindicated interventions, and providing contradictory care instructions to patients enrolled in multiple programs.

Most post-discharge programs involve skilled nurse home visits, personal telephone calls, and attempts to gather patients' vital signs using telehealth equipment and devices installed in the patients' homes. This can add significant costs and complexity to post-discharge programs. However, the devices can let hospitals and care systems know when patients are having or have had a significant health ‘event.’ More problematic than the cost of such programs and technology is that changes in vital signs often become present after a significant medical event or health change has occurred.

To address this problem, hospitals and care systems must be able to incorporate all of the patient's diseases into a single post-discharge transitional care program. Or, better yet, provide comprehensive transitional care programs that manage patients before their admission, during the discharge and through the recovery period. However, due to limited resources, logistical limitations, high costs and difficulties with patient compliance, no program or system is currently available to meet these needs.

### SUMMARY OF THE INVENTION

The present invention pertains to novel medical transitional care patient management system and associated business method that provides a means to monitor patients and, collect, analyze and disseminate information related to a patient's health status before, during and after a care transition. If a patient's health status or compliance with their care plan is unsatisfactory, an alert is issued to designated recipients to alert them to opportunities for early intervention. Using a program that employs a plurality of mathematical algorithms and software instructions for analyzing data a customized individual care plans are developed incorporating the patient's primary disease, co-morbidities, medical and/or surgical procedures, and risk factors which together are called the patient “case mix”, and other patient information. The system and software components include an customized individual care plan (“ICP”) engine which receives the patient's case mix data, contact and other information, and health care provider contact information then constructs custom individualized care plans for each patient, based on their unique case mix. An Engagement engine that reaches patients through outbound and/or inbound telephony, and internet based technology, and an Alert engine which analyzes response trends, then issues alerts when responses indicate declining health status, or other adverse issues to which a health care provider should be alerted.

Individualized care plans (ICP) may contain one or more Callpaths, depending on the number of care transitions the patient experiences. The system software also includes an Engagement Engine, currently using interactive voice response telephony technology (IVR), that works in conjunction with the ICP engine to contact patients using outbound interactive voice response, email and text messaging to administer the patients' Callpath, i.e. to ask the questions in the patients' Callpath(s), record their responses, and, if indicated, provide informational statements to patients based on their responses via the means available to IVR and internet technology. The Engagement engine receives the patient input in response to the questions and writes the responses to the appropriate Patient Data Table. The Engagement engine also accepts inbound calls, and internet enabled communications initiated by patients, administers Callpath questions and statements, and writes the responses to the appropriate Patient Data Table.

Should patient responses to Callpath questions fall outside a question's, or series of questions′, satisfactory status parameters, or within adverse condition parameters an “alert” is created and disseminated by the system software to the contact(s) indicated within the ICP as an individual alert(s), or alert report. Alert parameters are contained in the ICP and alerts are sent through the Engagement engine to the designated recipient. Alert parameters and designated recipients may be set at the question level, and by question groups. Additionally, alert recipients may be set at the, question, question group, Callpath, and/or ICP levels.

An Alert Engine, using a plurality of mathematical algorithms and software instructions also identifies trends in patient responses to questions, or groups of questions. When an adverse trend is identified using information from the Patient data table and other data tables, the Alert Engine works in conjunction with the Engagement engine to provide alerts to the appropriate parties.

Patient data, patient case mix, patient questions, patient contacts, patient responses, alert data, patient outcome data, health care provider data, and other related data is stored and available for reporting and data analyses by system users.

### BRIEF DESCRIPTION OF THE DRAWINGS

FIG. 1 is a perspective view of the present invention medical transitional care patient management system and associated business method in its intended environment.

FIG. 2A is a perspective view of the present invention focusing on the business methodology and components of the system components and software packages and databases.

FIG. 2B is a continuation of FIG. 2A and shows a perspective view of the present invention focusing on the business methodology and components of the system components and software packages and databases.

FIG. 3 is a general flowchart of the present invention showing the main procedures necessary to carry out medical transitional care and management of patients.

FIG. 4 is a more detailed flowchart of the present invention showing the main procedures necessary to carry out the medical transitional care and management of patients.

FIG. 5 is a detailed flowchart of the present invention Individualized Care Plan Software. Process Module.

### DESCRIPTION OF THE PREFERRED EMBODIMENTS

### Definitions

CallPath(s): a specific series of questions and/or statements from the Question Library data table generated by the Individual Care Plan engine based on a patients case mix, risk factors, patient contact information, other patient information, and the type of care transition. Callpaths include valid response parameters for each question, alert parameters for each question and/or question group (s). Alert recipient contact information by question and/or question group(s) and/or Callpath may be assigned within each Callpath. The Callpath questions and statements are communicated to patients via the Engagement engine or live agent, and responses are recorded to a Patient data table. An individual care plan may contain one or more Callpaths, depending on the type and number of care transitions, and/or changes in their case mix and/or other information.

Co-morbidity is the presence of one or more additional disorders (or diseases) co-occurring, or coexisting, with a primary disease or disorder; or the effect of such additional disorders or diseases. The additional disorder may also be a behavioral or mental disorder.

Interactive Voice Response (IVR) is a telephony technology that enables a software system to initiate, dial, make verbal statements, receive data via manual input and/or voice response and/or short messaging service (SMS) record the data.

Transitional Care refers to the coordination and continuity of health care required before, during, and after a patient's movement from one healthcare setting to either another, or between health care practitioners and settings as their condition and care needs change during the course of a chronic or acute illness. Each change in setting is called a “care transition”. Care transitions also include those made to and from a patient's home or residence. For example, transitional care would include the period a patient prepares for surgery while at home, the care transition to the health care facility (e.g., surgery center or hospital), the care transition from the facility back to the patient's home, and the period thereafter as the patient recovers in their home, the recovery period.

Generally, the present invention is a medical transitional care patient management system and associated business method that provides a means to monitor a patient's health status, collect health related data, provide patients with information, and disseminate collected patient data to designated recipients, including alerting them to adverse patient issues identified from the collected data before, during and after a care transition. Using a program that includes a plurality of mathematical algorithms, and software instructions customized individual care plans (ICPs) are developed that incorporate each patient based on their case mix factors (i.e. their primary disease, co-morbid diseases, medical and/or surgical procedure(s), and certain risk factors) and type of care transition, contact information, and other information. The ICP contains patient health status surveys administered by the system, called ‘Callpaths’. The CallPath surveys are administered by the system and questions related to a patient's health status and compliance with care instructions, and provide information to patients. Responses are recorded via patient input and “alerts” to adverse changes in health status or compliance in accordance with the ICP as determined by the software are issued to designated contacts informing them of the adverse issue so they may arrange intervention. The alerts may be transmitted to designated contacts in real-time, through periodic reporting, or on demand through an Internet web portal or system user interface. Other reports and data analytics, are also available.

The conventional method, prior to this invention, is based on treating the most serious of a patient's disease states, for example congestive heart failure (CHF). All other disease states are considered additional risk factors for a readmission under CHF. The conventional method involves a significant amount of personnel resources, particularly nursing personnel to consistently reach out and communicate with patients using manual means via personal telephone calls or personal encounters, to patients to see if they are satisfactory.

Under the conventional procedures, there is a significant risk of readmission for patients with multiple co-morbidities, since not all of the patient's disease states are being managed, and the impact of other case mix variables are focused on their effect on the primary disease. Readmission of patients discharged from acute hospitals within 30 to 60 days for complications and issues related to co-morbid diseases are significant, even while enrolled in programs to address their primary diagnosis.

Most existing transitional care programs are acute hospital post-discharge programs that attempt to coordinate the continuity of care after a care transition to the home. They typically involve skilled nurse home visits, personal telephone calls, and attempts to gather patients' vital signs using telehealth equipment and devices installed in the patients' homes. The labor and equipment required by these methods add significant cost and complexity to post-discharge programs. The devices can let hospitals, health care providers, and health care systems know when patients are having or have had a significant health ‘event.’ However, more problematic is that changes in vital signs typically present themselves after an event or health change has occurred.

To address this problem, hospitals, health care providers, and care systems should incorporate a patient's complete case mix into a single transitional care program. The focus should be on the entire patient's case mix, not a primary disease. However, due the conventional practices, logistical limitations, high labor and equipment costs, and limited resources, no program or system is currently available to meet these needs.

In contrast to the conventional processes for managing patients post-discharge transitional care, that relies on standardized experience based programmatic practices and protocols, based on a patient's primary disease, and applies the same practices, protocols, and to all patients with that primary disease, what is termed ‘care averaging’, the Process does not.

In contrast to the conventional processes that involve extensive manual processes for care plan development and administration, the Process does not.

In contrast to the conventional processes that involve expending resources automatically without regard for their necessity, the Process does not.

In contrast to the conventional processes that limit transitional care to patients post-discharge from an acute hospital, this Process does not.

While it is known to use interactive voice response (IVR) and Internet technology to gather data over the telephone and internet communication, the specialized nature of the individualized care plan creation, CallPath creation, and the transitional care patient management methodology, makes this very specific implementation of IVR and Internet technology unique and heretofore unknown process. Specifically, proprietary aspects of this Process include the following:

1) The ability to enter a patient's complete case mix components, patient information, and health care organization, health care facility and health care provider information, into a computer system and have the system build, in real time, a single unified care plan that addresses all of that patient's known case mix factors.

2) The ability to automatically implement the custom created individual care plan callpaths, so that the system reaches out to the patient to ask specific questions, and provide statements (informational and motivational) based on the responses to questions.

3) The use of automated data collection systems to trend health indicators in such a way as to identify or predict the need for patient interventions without having to rely on changes in patients' vital signs.

4) The ability to react differently and dynamically to an individual patient based on the value of their input (e.g., incorporation of a scripting engine to determine “jump” logic within each Callpath.)

5) The ability to validate patient entries against both specific and range-based data to determine if an alert exists or if a script needs to be run, and if so, which script to run.

6) The ability of the system to allow patients to correct and/or re-enter specific data items.

7) The ability of health care organizations, health care facilities, and health care providers to have immediate access to recorded data without the need for manual transcription or data set transmission from a device or appliance.

8) The ability of the health care organizations, health care facilities, and health care providers to set up security by user, group and/or job description.

9) The ability of the system to directly interface with health care organizations, health care facilities, and health care providers of record and State submission systems.

Components of the Process

The Individual Care Plan engine—Receives data regarding the patient, their contact information, their primary disease, co-morbidities, medical and/or surgical procedures, and risk factors which together are called the “case mix” and other patient information and uses the data to construct custom individualized care plans (ICP) for each patient, based on their unique case mix. An ICP contains one or more Callpaths which contain questions and statements to be administered to patients, sometimes referred to as ‘surveys’ or ‘health status surveys’. Multiple Callpaths may be created if the patient experienced or will experience more than one care transition, their case mix or other information changes. Alert parameters as well as alert recipients may be designated at the Callpath question level, Callpath question group level, Callpath level and ICP level.

The Engagement engine—Works in conjunction with the ICP engine to contact patients using outbound interactive voice response, email and text messaging to administer the questions and statements in the patients' Callpath(s) to patients and transmits the data input to the appropriate Patient data table. It also uses inbound communication technology, such as; inbound telephone calls, an Internet web portal, and mobile applications, working in conjunction with the ICP engine to administer ICP Callpath(s) to patients and transmits the data input to the appropriate Patient data table. Alerts may be generated and issued to designated a party(ies) by the Engagement engine related to the process of contacting patients and/or their designated alert recipients, based on designated parameters, generally due to bad or corrupted data, and/or failure to establish contact with a patient over one or more attempts to administer Callpath(s)

The Callpath survey alerts—Each ICP contains one or more Callpath surveys. The ICP sets Callpathalerts at the question, question group, Callpath, and/or ICP levels. Working in conjunction with the Engagement engine, alerts are issued to the designated recipient(s) when a response to a question, or question group falls outside the patient's satisfactory response parameters, within adverse response parameters, invalid response parameters, and/or the Patient. Engagement engine's failed contact parameters. Alert recipients are set at the question, question group, Callpath, and/or ICP levels.

The Alert engine—using a plurality of mathematical algorithms and software instructions it identifies trends in patient responses to questions, or groups of questions over multiple Callpath surveys. When an adverse trend is identified, the Alert Engine works in conjunction with the engagement engine to provide alerts to the appropriate recipient(s) designated by the question, question group, Callpath, and/or ICP.

The System User Interface—Provides a means for authorized users to view, edit, add and delete data from the data tables. Hierarchical system security access prevents the reading, editing, and writing of data by users without the appropriate security credentials.

The Patient data tables—Records the contact data (time, date, contact method, contact disposition, etc.), the call plan questions asked, call plan statements made, and input data for each patient interaction. System software analyzes the data using a plurality of mathematical algorithms and software instructions to build data models and for use in algorithms and software instructions.

The Referral Source data table—Records information regarding the organizations that provide patients for enrollment into the transitional care patient management program system.

The Contacts data tables—Regards data pertaining to individual contacts at the various Referral Sources and the alert recipient contact information associated with those referral sources.

The Question Library data table—Records and holds questions that are used to build Callpaths.

The User data table—Records system user information and their and Referral Source of affiliation. It also relates to the Contacts data tables if the user is also a contact and/or alert recipient contact.

The Security data table—Records and maintains security settings for users.

The scripting engine—Allows for building scripts into the questions to manage branching logic during a patient interaction, so that the system can react differently and dynamically based on the patients' responses to questions.

The records transfer system—Builds presentation files that represent patient responses and data models for customers to access, view, print, and/or transmission.

The electronic date interface system using wired and/or wireless means of communication with the information and record systems of health care organizations, health care facilities, health care providers, governmental entities, and others in a manner compliant with state and federal regulations for the purpose of transmitting patient medical and other information to the appropriate data tables.

The present invention incorporates each patient's complete case mix, rather than stratifying patients based on a primary disease state. This allows health care organizations, health care facilities, and health care providers to build transitional care plans in real time that take into account the patients' known case mix factors: primary diagnosis, co-morbidities, medical and/or surgical procedures, and risk factors. The present invention does not create a care plan “silo”, focused on a single disease, but rather builds a unique care plan tailored for the individual patient that takes into account the patient's known case mix factors. The new Process precludes the need for health care organizations, health care facilities, and health care providers to have to follow standardized programmatic practices and protocols based on the primary diagnosis, and replaces them with case mix risk based process that engages patients as needed, not based on a standardized protocol based on a single diagnosis. The present invention eliminates the costs associated with putting patients into multiple: disease management, transitional care, or post-discharge programs, by combining all of them into a single, unique, unified program. The new Process reduces the need for the programmatic outreach upon which most programs are built. The process functions as an automated early warning system that enables our health care partners to dedicate their resources where and when they are needed.

Advantages of the Present Invention Include:

a) Care plans are developed automatically by simply entering the patients' known case mix factors and other information, reducing costs for hospitals and care systems.

b) No need for health care organizations, health care facilities, and health care providers to maintain expensive nursing call centers reaching out to patients that are doing well in search of patients requiring intervention.

c) Eliminates the need for health care organizations, health care facilities, and health care providers to provide programmatic transitional care programs based on a patient's primary disease state.

d) Eliminates the need for health care organizations, health care facilities, and health care providers to visit or call to check on every patient post-discharge through the provision of discharge instructions and monitoring process provided by the software and business method.

Automatically persistently monitors patients to gather and trend data points and provide the data back to hospitals and care systems, including, but not limited to alerts to designated contacts.

Automatically identifies leading indicators, and/or trends, that identify the need for intervention often before they manifest into changes in a patient's vital signs, and alerting designated contacts to the patient's adverse events, issues or changes in health status.

Allows health care organizations, health care facilities, and health care providers to identify and manage patients by exception. Persistent monitoring enables them target their resources expenditures on patients requiring care assistance when the patient needs it.

Patients can use the system themselves for certain programs. All data is secured throughout the process, affording complete confidentiality of protected information.

The present invention is far more cost effective by enabling customers to implement the practice of management by exception. The present invention monitors patients over longer periods and far more frequently than would be practical using live call centers. And can result in improved outcomes, while lowering health care costs. The present invention manages a patient's known case mix factors, which both improves outcomes and patient satisfaction.

Exemplary Features of the Process

The Process is a unique and proprietary for managing patient transitional care before, during and after a care transition, for example in preparation for a surgical procedure at a hospital, upon discharge, and during their recovery. The process for managing the care transition prior to a care event, such as a hospital admission; post-discharge care transition and for a short period thereafter; and finally during the recovery period, usually occurs at the patient's or patient agent's residence. Following is an example, within a short time span after the patient arrives home from a hospital and the patient is to be contacted using interactive voice response technology.

1) The hospital refers the patient along with the patient's care instructions, case mix and other patient information.

2) The patient data is entered into the. Process through automated data transfer or manual data entry.

3) Using the proprietary algorithms and software instructions, the Process creates an individual, customized care plan with Callpaths for each patient, based on that patient's unique case mix (primary disease, co-morbidities, surgical and/or medical procedures, and risk factors) patient contact information, and alert recipient information. The individualized care plan (ICP) is generated and Callpath(s), a series of questions and statements that directly address each patient's needs based on their unique case mix and other information.

4) Using technology such as outbound and/or inbound interactive voice response (IVR), web portals, Internet technology, and mobile applications the Process reaches out to the patient and asks the Callpath questions and delivers the information included by the Process for that patient's ICP.

5) The Process allows for setting thresholds for each question or group of questions that can cause alerts to be generated whenever a patient's answer to an individual question, or question group is: a) greater than, b) less than, or c) equal to d or within the specified threshold value, range, or other indication of an alert.

6) The Process allows for each question, question group, Callpath and/or individual care plan to be associated with one or more ‘alert persons’ who may be notified in the event a patient alert is received by the Process.

7) The system prompts the patient to enter their unique identification (ID) information or other validation means, by either speaking or keying their verification information, or into the system through the phone, Internet or other polling method.

8) The system manages security to ensure the patient is the correct person intended for the polling.

A) If by telephone, the system requests the patient enter their ID or other validation before starting the Callpath.

(i) If no answer, the system records a ‘no answer’ disposition for the call and calls back in a predetermined period of time.

(ii) If a hang-up, the system records a ‘hang-up’ disposition for the call and calls back in a predetermined period of time.

(iii) If a busy signal is received, the system records a ‘busy’ disposition for the call and calls back in a predetermined period of time.

(iv) If a voice mail, or answering machine answers, the system may leave a message or simply hang up. If a message is left, the system records and record a ‘voice mail message provided’ disposition for the call. If no message is left, then the system records a ‘no answer’ disposition for the call. In either case the system calla back in a predetermined period of time.

(v) If no contact is made with the patients after a predetermined number of contact attempts, the system can create a ‘call alert’ that is issued to a human contact manager, and/or provided to a designated contact.

(vi) Once contact is established, the system prompts the caller to input the first data item to be collected. Once the data has been received by the system, the system compares the entry against a predetermined set of valid answer data. Conditional scripting can be associated with each item in the valid answer data set causing the system to react differently based on the data input by the caller.

If the input data does not match any of the accept entries in the predetermined set of valid answer data, the system returns an “invalid entry” response to the patient and prompts the patient to re-enter the data. After a preset number of invalid entries have been received, the system will end the interaction session and create an error record entry in the system database.

If the input data matches a valid answer entry, any program script associated with that answer is executed. This can cause the system to skip over one or more system prompts, allowing the caller to complete the session without having to respond to non-applicable system prompts, and lessening the time callers spend to complete the outcomes report.

If no script is associated with a particular system question answer or answer set, the system will record the data input by the caller and move on to the next prompt in order.

The caller can press a pre-assigned key (e.g., the * key on the phone), or speak or otherwise enter a pre-determined entry to have the system “backup” and repeat a prompt. When this is done, the entry associated with the repeated prompt will overwrite any original entries.

1) The system checks to see if all the needed data has been collected.

a. If not, the system can be set to replay missed prompts, accept partial data records and/or call the patient back to gather the remaining data.

b. If all of the data has been collected, the system can verify receipt of the data and play any additional assigned prompts for the patient.

c. The patient can have the system back up to repeat a question. Since the system is writing to the database in real time, as the data is input, there is no additional “save” process required of the patient.

d. Incomplete or error records are marked for editing.

e. Error records can be edited in real time over the phone, during a follow up call to the patient, or edited over the Internet using a provided system user interface.

2. The received data record is stored on the system database and can be accessed via the Internet or “pushed” or “pulled” to a system of a hospital or care system. Data can be transferred in batch, real-time or periodic data exchange.

a. The system provides a means for the health are organizations, health care facilities, and health care providers or other authorized party to access the data records of their patients over the Internet or via a system user interface.

i. Data can be edited online in the system.

ii. Data can be locked to prevent subsequent changes.

iii. Data can be exchanged for use in other health care organizations, health care facilities, and health care providers electronic data information systems.

iv. Data can be transmitted in batch or real-time modes, as database records, formatted reports, or formatted data.

v. Data records can be printed from the system.

vi. Where permitted by law, data records can be directly sent to a State CMS system or other permissible system.

vii. All data can be encrypted to meet state and federal requirements.

3. Users can be set up on the system and assigned different degrees of security by their health care organizations, health care facilities and health care providers, and other organizations.

i. They can establish security by “groups” and then assign their users security rights by assigning them to a defined group.

ii. They can establish security by job description and then assign their users security rights by assigning them to a pre-defined job description.

iii. They can assign each system user, some or all of the following security rights:

a. Log in rights (user ID and pass rd)

b. View specified data

c. Edit specified data

d. Add new data

e. Delete data

f. Download data

g. Run reports

h. Transmit data

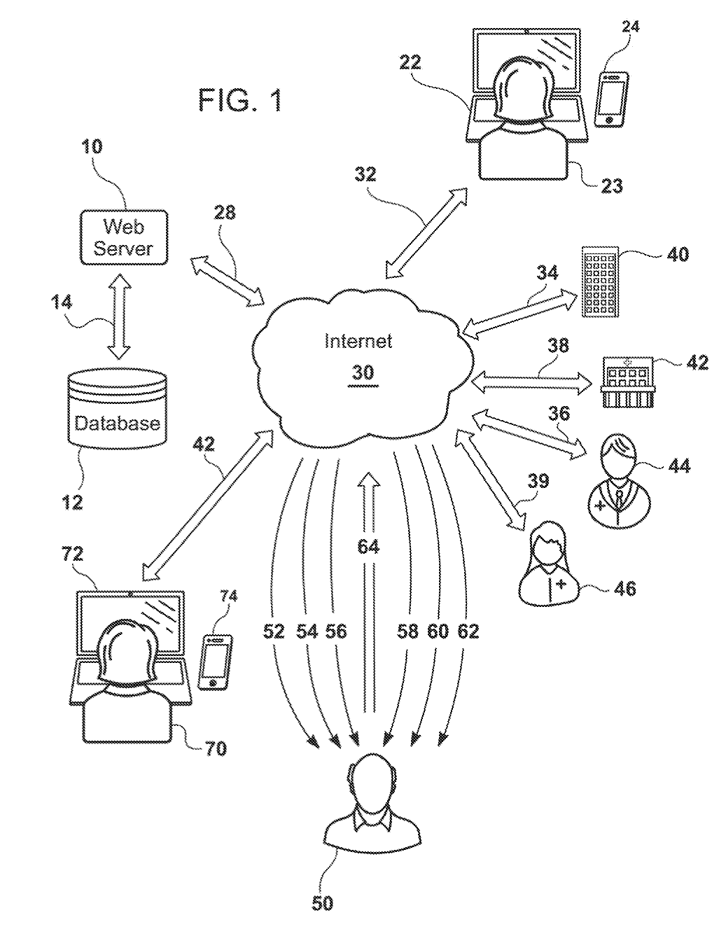

Now referring to FIG. 1 which shows a perspective view of the present invention medical transitional care patient management system and associated business method in its intended environment. FIG. 1 shows the present invention web server 10 in wired and/or wireless communication 14 with the database 12. All communications with the web server 10 is for private and authorized use and not available to the public. Standard password and other similar technology is utilized to maintain the limited access to the system. The present invention web server 10 is also in wireless and/or wired communication 28 with the internet 30. A live agent (user) 23 is shown using a computer 22 and/or mobile device 24 to communicate wirelessly and/or using wired technology 32 with the Internet 30 to access the present invention web server 10 input data into the web server 10 and database 14 and other responsibilities. Also shown is a health care organization 40 and health care facility 42, each communicating wirelessly and/or using wired technology 34,38, respectively, with the internet 30 which allows authorized access to the present invention web server 10 and database 12. Medical professionals or health care providers 44, and caregivers 46 can also communicate wirelessly and/or use wired technology 36, 39, respectively, with the internet 30 to access the present invention web server 10 and database 12. The patient or patient agent (e.g. family member) 50 can access the present invention web server 10 and database 12 by communicating wirelessly and/or use wired technology with the internet 30 by utilizing cell, mobile and land phones 52, facsimile (fax) 54, email 56, SMS text 58, Web portal or mobile applications 60, or other methods 62. A live agent (user) 70 is shown communicating wired and/or wirelessly and/or using wired technology 42 with the internet 30 to access the present invention web server 10 and database 12 while simultaneously communicating wired and/or wirelessly 42 with the internet 30 to communicate with the patient or patient's agent 50 using a computer 72 or mobile device 74 by phone 52, fax 54, email 56, SMS (text) 58, web portal or mobile application 6 or other methods 62.

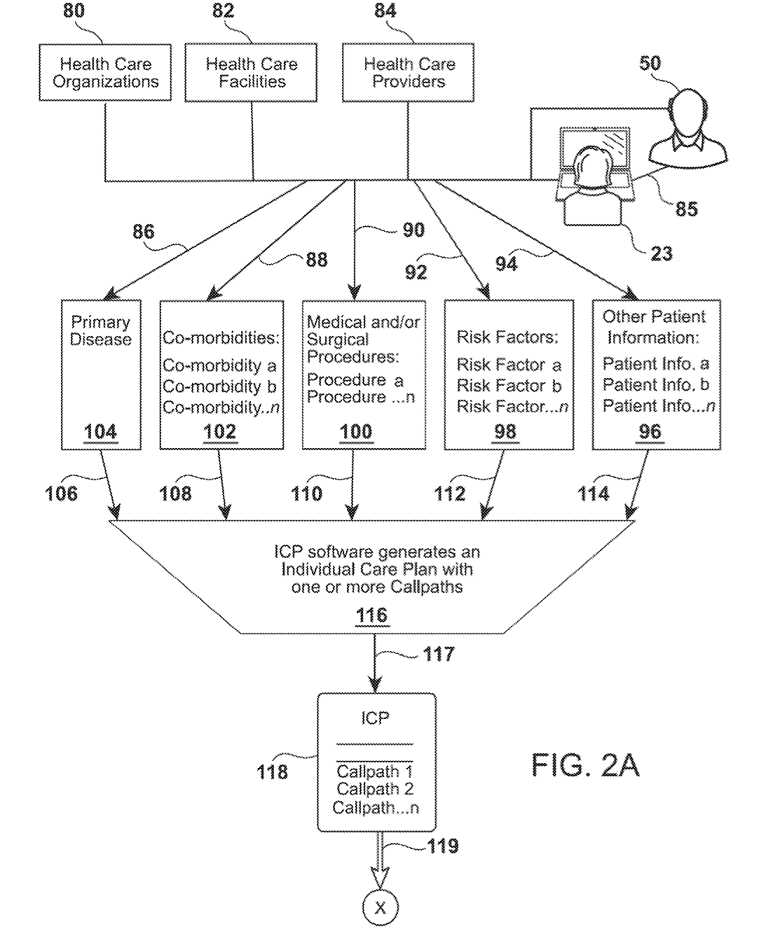

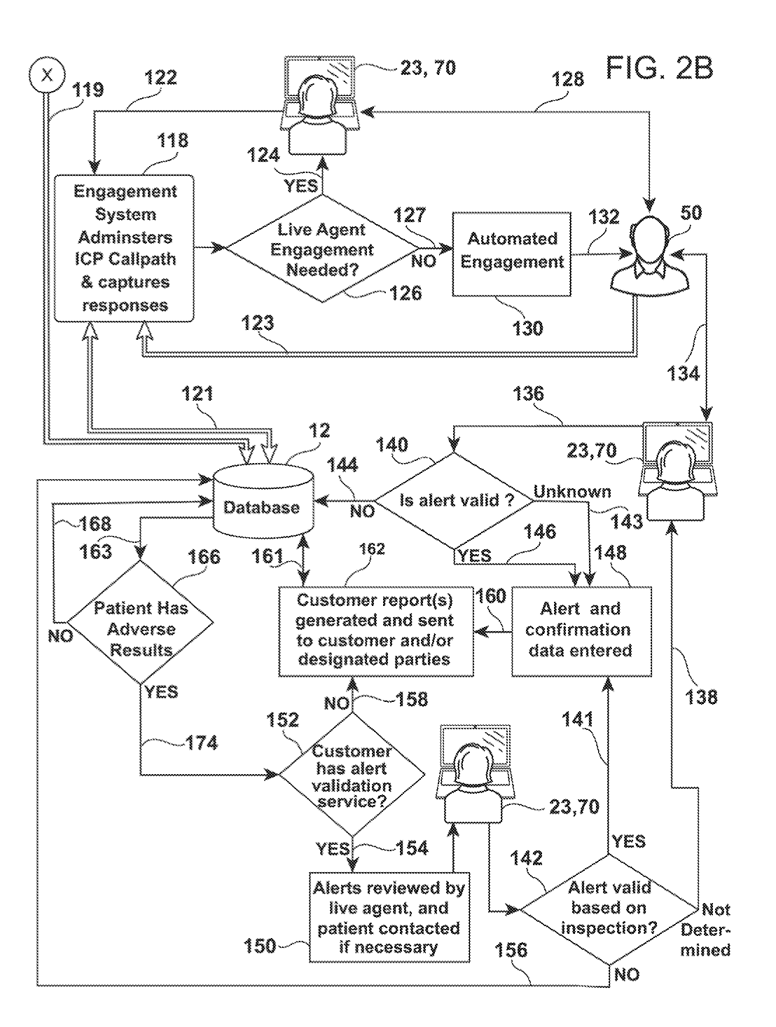

Shown in FIG. 2a (and continuing in FIG. 2b) is a perspective view of the present invention focusing on the business methodology and components of the web site and software packages and databases. Health care organizations 80, health care facilities 82, health care providers 84, the patient or patient's agent 50 independently or by communicating with a live agent 23 using wired and/or wireless communication means 85, or a live agent (user) 23 can communicate patient specific information and data that is funneled towards and coalesced for the generation of a individualized care plans 118. The health care organizations 80, health care facilities 82, health care providers 84 the patient or patient's agent 50, and live agent (user) 23 can transfer data and information about the primary disease 104 using wired and/or wireless communication means 86, co-morbidity 102 using wired and/or communication means 88, specific medical and/or surgical procedures 100 using wired and/or wireless communication means 90, risk factors (e.g. age, length of stay in a facility) 98 using wired and/or wireless communication means 92, other patient information 96 using wired and/or wireless communication means 94 and other patient information (e.g. contact information, billing information) 96 using wired and/or wireless communication means 94.

Once this patient specific information is recorded within this layer of the software, the patient related primary disease 104 information and data is transferred using wired and/or wireless communication means 106, any patient related co-morbidities 102 information and data is transferred using wired and/or wireless communication means 108, any patient related medical and/or surgical procedures 100 information and data is transferred using wired and/or wireless communication means 110, risk factors 98 is transferred using wired and/or wireless communication means 112 and other patient information 96 information and data is transferred using wired and/or wireless communication means 114 is processed and transferred to the Individual Care Plan (ICP) software module 116 that generates a customized individual care plan (ICP) with one or more Callpaths 118 specific to the individual patient which is transmitted using wired and/or wireless communication means 119 to the database (FIG. 2B) 12.

FIG. 2b continues from FIG. 2b with the individual care plan (CP) (FIG. 2b, 118) data transmission using wired and/or wireless communication means 119 to the present invention database 12. FIG. 2b shows a live agent (user, medical professionals, or other personnel) 23, 70 inputting a patient's 50 individual conditions and other information, For example congestive heart failure (CHF), Chronic Obstruction Pulmonary Disease (COPD), angina, diabetes, hypertension, and the patient's preferred contact time and method of contact that generates an individualized care plan (ICP) and Callpaths. Using wired and/or wireless communication 122 to access the Engagement System Module 118 that administers the ICP, Callpaths and captures patient 50 responses, and transmits data to and from the present invention database 12 using wired and/or wireless communication methods 121. The live agent 23, 70 is also using wired and/or wireless communication 128 to establish a communication pathway with the patient 50, such as by telephone. The live agent adds and edits the patient's existing patient data file based on the information obtained from the patient, Together with the existing information in the patient record the information gathered from the patient will aid in the creation of an Individual Care Plan and Callpaths. The Engagement System Module 118 determines that an event must be provided, and if Live Agent Engagement Needed query 126 and if YES, routes the request 124 to live agent 23, 70.

Communication 128 consists of wired and/or wireless means and creates a communication path between the live agent 23,70 and the patient 50. Alternately, if the event is non-threatening or does not require live agent 23, 70 to administer an ICP Callpath, provide advice or assistance (NO) 127, an automated engagement (e.g. interactive voice response telephone call) 130 is provided using wired or wireless means of communication 132 to patient 50. Also shown is the patient 50 initiated communication with the Engagement System Module 118 using wired and/or wireless communication means via web portal, mobile applications, inbound telephone, or other means 123. Near the right middle of FIG. 2b the live agent 23,70 is determining whether data received meets the requirements of a valid alert 140. If the alert is validated (YES) 146, then the alert information and confirmation data is input 148, and sent using a wired and/or wireless means of communication 160, and alert(s) and/or customer report(s) are generated and sent to customers and/or the designated party(ies) 162. Using wired and/or wireless means of communication 161 the data is transferred to the present invention database 12 for the selected patient. Should the alert be determined by query 140 to be invalid (NO) 144 the data is transferred to the present invention database 12 for the selected patient. If the alert is valid query 140 is (UNKNOWN) 143, due to unsuccessful attempts to contact the patient or other reasons, the live agent 20,70 will proceed as if it were confirmed, the unconfirmed data is entered 148 and transmitted for report generation 160 and alert(s) and/or customer reports are sent to customers and/or designated parties 162 and recorded in the present invention database 12. The present invention database 12 can periodically query 163 if the patient has any adverse results 166, and if (NO) 168 this information is transferred to the present invention database 12. Alternatively, if query 166 is (YES) 174, the customer alert validation services query 152 determines if the customer subscribes to live agent verification of alerts, if query 152 is (NO) 158 the alert(s) which include response data, date, and patient identifiable information and other information as indicated and/or customer report (s) are generated and sent to customer and/or to designated party(ies) 162. Using wired and/or wireless means of communication 161 the data is transferred to the present invention database 12 for the selected patient. If query 152 is (YES) 154, then alerts and patient records are reviewed by live agent 23, 70 and patient is contacted if necessary 150 as determined by the alert valid based on inspection query 142. If query 142 is (YES) 141 the alert and confirmation data are input, and sent using a wired and/or wireless means of communication 160, then alerts) and/or customer report(s) are generated and sent to customers and/or the designated party(ies) 162. Using wired and/or wireless means of communication 161 the data is transferred to the present invention database 12 for the selected patient. If the alert was determined to be invalid by query 142 (NO) 156 the data is transferred and recorded by the present invention database 12 for the selected patient. If the alert validity query 142 is (NOT DETERMINED) 138 a live agent 23,70 establishes a communication pathway using wireless and/or wired communication, such as a telephone or other means 134 with the patient 50 and verifies the validity of the alert with the patient and inputs that information. Should the alert be determined by query 140 to be invalid (NO) 144 the data is transferred to the present invention database 12 for the selected patient. If the alert is valid query 140 is (YES) 146 then alert confirmation data is entered 148 and transmitted for report generation and alert(s) and/or customer reports are sent to customers and/or designated parties 162 and recorded in the present invention database 12. If the alert is valid query 140 is (UNKNOWN) 143, due to unsuccessful attempts to contact the patient or other reasons, the live agent 20,70 will proceed as if it were confirmed, the unconfirmed data is entered 148 and transmitted for report generation 160 and alert(s) and/or customer reports are sent to customers and/or designated parties 162 and recorded in the present invention database 12.

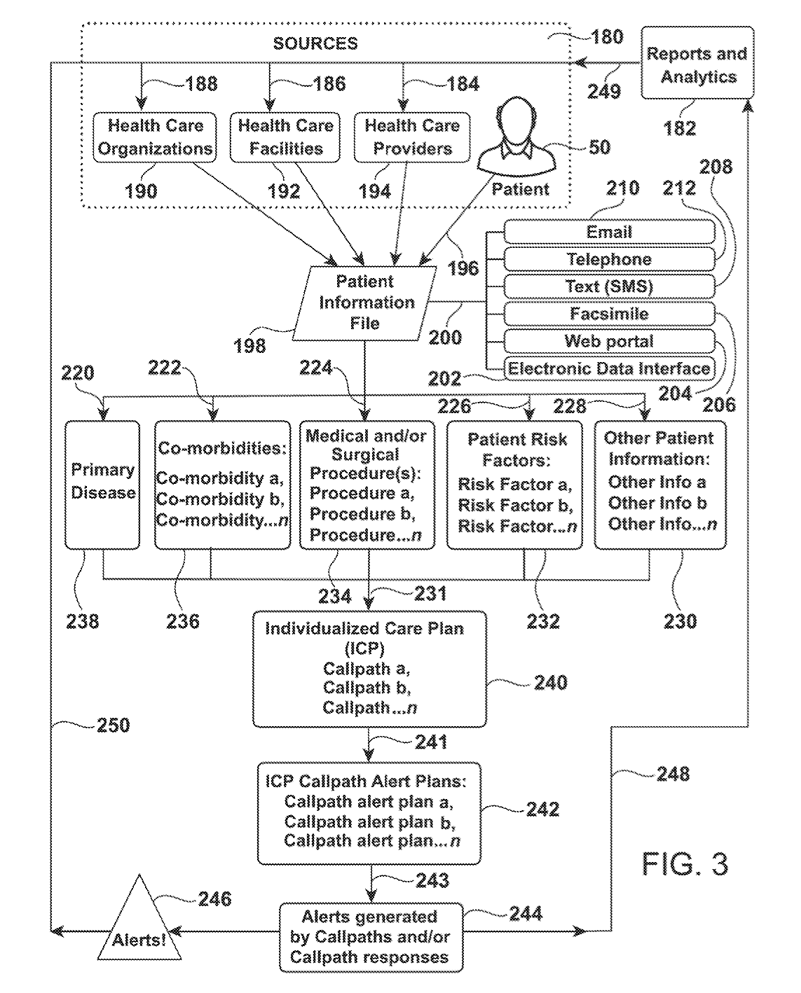

FIG. 3 is a general flowchart of the present invention showing the main procedures necessary to carry out medical transitional care and management for patients. FIG. 3 shows the sources 180 of the patient data and information generated from a health care organization 190, health care facility 192, health care providers 194, and the patient or patient's agent 50 collated in a patient information file 198. The patent information file resides in the present invention central database 12 for data analysis, processing, updating and generation of reports. Patient data and information can be transferred, under an authorization protocol, to the patient information file 198 by email 210, telephone or cell phone 212, SMS text 208, facsimile (Fax) 206, web portal and user interface 204 or any other electronic data interface means 202. The patient information file 198 consists of the primary disease state(s) 238, co-morbidity(ies) 236, medical and surgical procedure(s) 234, patent risk factors 232, and other patient information 230. The data and information from the patient information file 198 is used to generate the individualized care plans (ICP) 240 which includes individualized care plan CallPaths and alert plan parameters 242. Alerts are generated by CallPaths and/or CallPath responses 244. When an alert is generated 246, it is transferred, by wired or wireless means 250, via a transfer line 188 to the health care organization 190, a transfer line 186 to the health care facility 192, a transfer line 184 to health care providers 194. Also, when an alert is generated 244, the data and information regarding the alert it is transferred, by wired and/or wireless means 248 to the central database which produces reports and analytics 182, transferred via line 188 to the health care organization, line 186 to the health care facility 192, line 184 to health care providers 184.

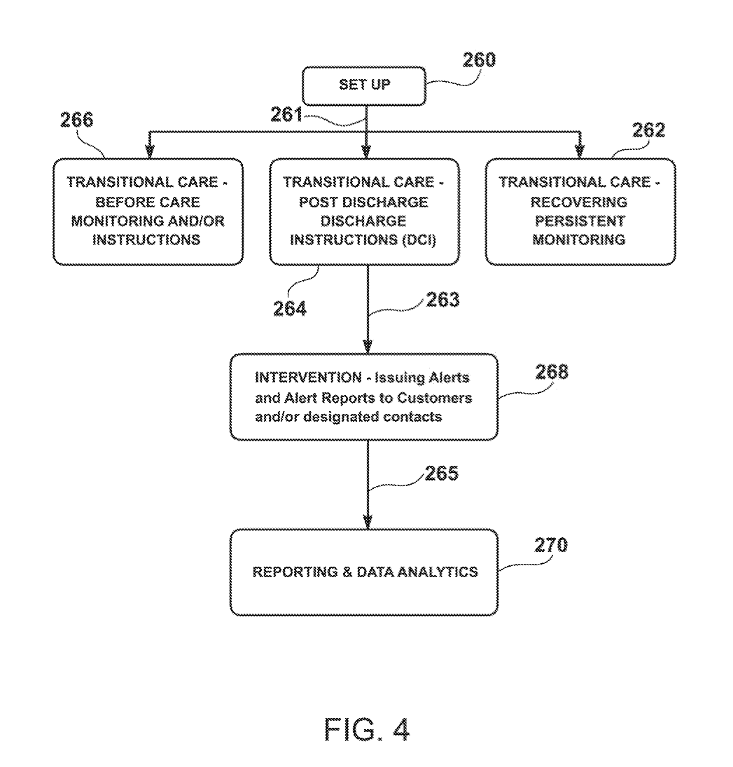

FIG. 4 is a more detailed flowchart of the present invention showing the main procedures necessary to carry out the medical transitional care and management of patients. FIG. 4 shows a start set up box 260 which is a module of the present invention web server 10 and software that further divides care management into transitional care before care monitoring and/or instruction 266, transitional care post discharge and during discharge instructions 264, and transitional care during recovering events and persistent chronic monitoring 262. Boxes 262, 264 and 266 move to Box 268 which details the present intervention monitoring procedures which issue alerts and alert reports to customers and/or designated contacts. Box 268 moves to Box 270 which details the transfer to the health care organization 190, health care facility 192, health care providers 194 reporting procedures and data analytics 270

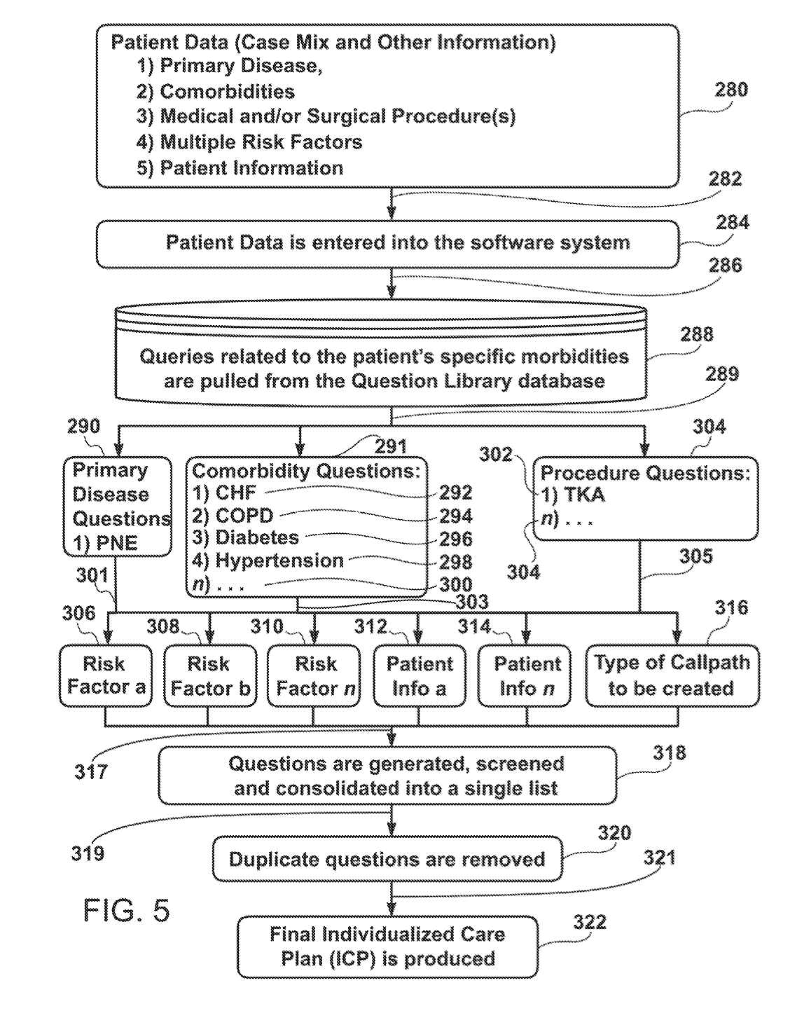

FIG. 5 is a detailed flowchart of the present invention Co-Morbidity or Multi-Morbidity Software Process/Response Module. Box 280 represents a patient who has multiple co-morbid disease states, for example, congestive heart failure, chronic obstructive pulmonary disease, diabetes and hypertension, co-morbidities, medical and surgical procedures (e.g. Total Knee Replacement (TKA), risk factors and patient information. This information is input into the Patient Information Software Module 284 via electronic wired and/or wireless transfer means or manual input. Queries sequences and mathematical algorithms software instructions regarding the acquired information from the question library database and that are related to the patient's specific co-morbidity(ies) 288 are searched in the Question Library module of present invention database 12. Examples of specific questions for congestive heart failure 292, chronic obstructive pulmonary disease 294, diabetes 296, hypertension 298 and other disease states and conditions 300 are associated with the co-morbid disease questions 291, an example of specific questions for pneumonia (PNE) and other diseases are associated with the primary disease questions 290. and the risk factors 1 306, risk factor 2 308 risk factor n 310, patient information 1 312, patient information n 314 and type of CallPath(s) 316 that will be generated, Questions are created, screened and consolidated into a single list 318. The Software Process/Response Module deletes that duplicate information, conducts cross-checking and ranking data, and utilizes predictive information 320 that are compiled into an individualized care plan (ICP) 322 specific for the patient. Once created, users maintain the ability to edit. ICP's and their component Callpaths to meet patient needs.

Any patents and patent applications mentioned in the specification are indicative of the levels of those skilled in the art to which the invention pertains. These patents and applications are incorporated herein by reference to the same extent as if each individual patent or application was specifically and individually incorporated herein by reference.

The foregoing description is illustrative of particular embodiments of the invention, but is not meant to be a limitation upon the practice thereof. The following claims, including all equivalents thereof, are intended to define the scope of the invention.

What is claimed is:

1. A method for collecting data during a medical transitional care period and generating an individualized care plan, the method comprising the computer-implemented steps of:
a) receiving patient data from a referral source such as a hospital or care system that includes all of the patient's disease states;
b) evaluating all of the disease states for a specific patient and creating an individualized care plan for the specific patient through a set of validity rules;
c) initiating action within a computer system based on the individualized care plan data to connect with the patient and correlate the data to a database,
d) returning one or more message(s) to the patient,
e) executing additional software instructions, and/or any combination of these actions; and;
f) organizing the data in such a manner as to create trending charts or results records in the database that can be used to predict the need for interventions.

2. A method as recited in claim 1, wherein the patient data is received electronically using web services, a system or other automated means to load patient data.

3. A method as recited in claim 1, wherein the ICP is updated whenever new disease states are changed, added or removed to a patient's data record.

4. A method as recited in claim 1, wherein the data received is input from a telephone, web services, system or other automated means.

5. A method as recited in claim 1, wherein the data received is input manually by a person that is reporting their own data.

6. A method as recited in claim 1, wherein the patient initiates contact with the system to report their data.

7. A method as recited in claim 1, wherein the data received is evaluated at a time subsequent to receiving the data, or is evaluated by a separate or third-party system.

8. A method as recited in claim 1, wherein the data received results in an additional application or code block to begin execution.

9. A method as recited in claim 1, wherein the data meets the reporting requirements of state and federal governmental program mandates for hospitals, care systems and regulatory authorities.

10. A method as recited in claim 1, wherein the results data meets the reporting requirements of state and federal governmental program mandates for health services reporting.

11. A method as recited in claim 1, wherein the results data meets the reporting requirements of state and federal governmental program mandates for disabled and/or disadvantaged children.

12. A method as recited in claim 1, wherein the results data meets the reporting requirements of state and federal governmental program mandates for the mentally impaired.

13. A method as recited in claim 1, wherein the results data meets the reporting requirements of state and federal governmental programs that mandate periodic reporting.

14. A method as recited in claim 1, wherein the results data is transferred to a computer system.

15. A method as recited in claim 1, wherein the results data is made available to the person who entered t for the purposes of viewing the data modifying the data, completing the data record, downloading the data record, transferring the data record, printing the data record and/or any combination of the above.

16. A method as recited in claim 1, wherein the results data is made available to the payer and/or other authorized agents of the patient, for the purposes of viewing the data, modifying the data, completing the data record, downloading the data record, transferring the data record, printing the data record and/or any combination of the above.

17. A method as recited in claim 1, wherein the identification of the caller or remote worker is authenticated using voice recognition and/or voice identification processes.

18. A method as recited in claim 1, wherein the data collected is used to model and/or trend provided services, or predict the efficacy of new or changes to existing services.

19. A business method designed to coordinate and monitor medical transitional care of patients having co-morbidity disease states, the method comprising the steps of:
a) receiving patient data from a referral source such as a hospital or care system that includes all of the patient's disease states;
b) evaluating all of the co-morbidity disease states for a specific patient and creating an individualized care plan for the specific patient through a set of validity rules;
c) initiating action within the computer system based on the individualized care plan data to connect with the patient and correlate the data to a database,
d) returning one or more message(s) to the patient,
e) executing additional software instructions, and/or any combination of these actions; and;
f) organizing the data in such a manner as to create trending charts or results records in the database that can be used to predict the need for interventions.

20. A business method as recited in claim 19, wherein the patient data is received electronically using web services, a system or other automated means to load patient data.

21. A business method as recited in claim 19, wherein the ICP is updated whenever new disease states are changed, added or removed to a patient's data record.

22. A business method as recited in claim 19, wherein the data received is input from a telephone, web services, system or other automated means.

23. A business method as recited in claim 19, wherein the data received is input manually by a person that is reporting their own data.

24. A business method as recited in claim 19, wherein the patient initiates contact with the system to report their data.

25. A business method as recited in claim 19, wherein the data received is evaluated at a time subsequent to receiving the data, or is evaluated by a separate or third-party system.

26. A business method as recited in claim 19, wherein the data received results in an additional application or code black to begin execution.

27. A business method as recited in claim 19, wherein the data meets the reporting requirements of state and federal governmental program mandates for hospitals, care systems and regulatory authorities.

28. A business method as recited in claim 19, wherein the results data meets the reporting requirements of state and federal governmental program mandates for health services reporting.

29. A business method as recited in claim 19, wherein the results data meets the reporting requirements of state and federal governmental program mandates for disabled and/or disadvantaged children.

30. A business method as recited in claim 19, wherein the results data meets the reporting requirements of state and federal governmental program mandates for the mentally impaired.

31. A business method as recited in claim 19, wherein the results data meets the reporting requirements of state and federal governmental programs that mandate periodic reporting.

32. A business method as recited in claim 19, wherein the results data is transferred to a computer system.

33. A business method as recited in claim 19, wherein the results data is made available to the person who entered it, for the purposes of viewing the data, modifying the data, completing the data record, downloading the data record, transferring the data record, printing the data record and/or any combination of the above.

34. A business method as recited in claim 19, wherein the results data is made available to the payer and/or other authorized agents of the patient, for the purposes of viewing the data, modifying the data, completing the data record, downloading the data record, transferring the data record, printing the data record and/or any combination of the above.

35. A business method as recited in claim 19, wherein the identification of the caller or remote worker is authenticated using voice recognition and/or voice identification processes.

36. A business method as recited in claim 19, wherein the data collected is used to model and/or trend provided services, or predict the efficacy of new or changes to existing services.
